(19) United States
(12) Patent Application Publication
(10) Pub. No.: US 2015/0291467 A1
(43) Pub. Date: Oct. 15, 2015

(54) METHOD FOR MANUFACTURING GLASS PLATE WITH WHICH WARPING DURING CHEMICAL STRENGTHENING IS REDUCED AND GLASS PLATE

(71) Applicant: ASAHI GLASS COMPANY, LIMITED, Tokyo (JP)

(72) Inventors: Takenori MIURA, Tokyo (JP); Yuichi SUZUKI, Tokyo (JP); Nobuaki IKAWA, Tokyo (JP); Hokuto KADOKURA, Tokyo (JP); Kohei YASUDA, Tokyo (JP)

(73) Assignee: ASAHI GLASS COMPANY, LIMITED, Tokyo (JP)

(21) Appl. No.: 14/751,321

(22) Filed: Jun. 26, 2015

Related U.S. Application Data
(63) Continuation of application No. PCT/JP2013/085126, filed on Dec. 27, 2013.

(30) Foreign Application Priority Data
Dec. 27, 2012 (JP) 2012-285511
Sep. 25, 2013 (JP) 2013-198470

(51) Int. Cl. C03B 18/20; C03B 18/18; C03C 3/087; C03C 21/00

(52) U.S. Cl. CPC C03B 18/20; C03C 21/00; C03B 18/18; C03C 3/087

(57) ABSTRACT

The present invention relates to a method for producing a float glass sheet, containing a step of melting a glass source material, a step of forming the glass melted in the previous step into a glass ribbon while allowing it to float on a molten metal, and a step of annealing the glass ribbon, in which the float glass sheet is a soda lime silicate glass, and in the forming step, a top surface of the glass ribbon that is opposite to a bottom surface thereof to be in contact with the molten metal is subjected to a dealkalization treatment in the float bath for 1 to 30 seconds and a surface temperature of the glass ribbon during the dealkalization treatment is 600° C. or higher.

### TECHNICAL FIELD

The present invention relates to a method for producing a glass sheet which is capable of reducing warpage during chemical strengthening and to a glass sheet, and further relates to a chemically-strengthened glass sheet produced through chemical strengthening treatment of the glass sheet.

### BACKGROUND ART

Recently, in flat panel display devices of portable telephones or personal digital assistances (PDAs), personal computers, televisions, car-mounted navigation display devices and the like, a thin sheet-shaped cover glass is often arranged on the front side of displays to cover a wider region than the image display area thereof, for protecting the displays and for improving the beauty thereof.

Such flat panel display devices are required to be lightweight and thinned, and therefore the cover glass to be used for display protection is also required to be thinned.

However, decreasing the thickness of the cover glass causes the problems that the strength is reduced and the cover glass itself may be broken by dropping, etc. during use or carrying and therefore its primary role of protecting the display device cannot be fulfilled.

Consequently, in already-existing cover glass, for improving the scratch resistance, glass produced according to a float method (hereinafter this may be referred to as float glass) is chemically strengthened to form a compressive stress layer on the surface thereof to thereby enhance the scratch resistance of the cover glass.

It has been reported that float glass is warped after chemical strengthening to lose flatness (PTLs 1 to 3). It is said that the warpage may be caused by the heterogeneity between the glass surface not in contact with a molten metal such as molten tin during float forming (hereinafter this may be referred to as top surface) and the glass surface being in contact with the molten metal (hereinafter this may be referred to as bottom surface), thereby providing a difference in the chemical strengthening degree between the two surfaces.

PTL 1 discloses a glass strengthening method that contains chemically strengthening glass after formation of an SiO₂ film on the glass surface to thereby control the amount of the ions to enter the glass during chemical strengthening. PTLs 2 and 3 disclose a method of reducing the warpage after chemical strengthening by controlling the surface compression stress on the top surface side so as to fall within a specific range.

Heretofore, for reducing the problem of warpage, there have been taken a coping method of reducing the strengthening stress produced by chemical strengthening or performing chemical strengthening after grinding treatment, polishing treatment or the like of at least one surface of glass to thereby remove the surface heterogeneous layer.

Further, PTL 4 discloses a chemical strengthening method of forming a surface compressive layer by employing a soda-ion reducing treatment in chemical strengthening of soda-lime float glass.

### PRIOR ART LITERATURE

### Patent Literature

### PTL 1: US Patent Application Publication 2011/0293928

### PTL 2: WO2007/004634

### PTL 3: JP-A 62-191449

### PTL 4: JP-A 61-205641

### SUMMARY OF INVENTION

### Technical Problem

However, in the method described in PTL 1 in which chemical strengthening is performed after formation of an SiO₂ film on the glass surface, the preheating conditions in the chemical strengthening treatment is restricted and further, there may be a probability that the film quality of the SiO₂ film would change depending on the conditions to therefore have some influence on the warpage. In addition, in the method where the surface compressive stress on the top surface side is controlled to fall within a specific range, as described in PTLs 2 and 3, there may occur a problem in point of the strength of the glass. Further, the chemical strengthening method described in PTL 4 is carried out, while a soda-ion reducing treatment is in an off-line mode, for 3 minutes or so at 550° C., and therefore the glass under the treatment would be deformed or would be distorted owing to temperature fluctuation so that the glass could not maintain flatness.

The method of performing grinding treatment, polishing treatment or the like on at least one surface of glass before chemical strengthening is problematic in point of improving the productivity, and therefore it is desirable to omit the grinding treatment, the polishing treatment or the like.

In a case where warpage may occur in some degree or more after chemical strengthening, the gap between glass and a stage would be too large in printing a black frame of a cover glass and therefore the glass could not be suctioned on the stage. In addition, in the case where the glass is used for a cover glass integrated with a touch panel, a film of ITO (Indium Tin Oxide) or the like may be formed thereon with large-sized condition in a later step, and in the step, there may occur some transport failure in which the glass sheet would be brought into contact with the air knife in a chemical liquid processing tank or in a washing tank, or there may arise some trouble in which the warpage may increase during the formation of ITO film and therefore the ITO film formation condition in the substrate peripheral part could not be suitable and would peel away. Further, in a case where there exists a space between an LCD (Liquid-Crystal Display) and the cover glass with a touch panel attached thereto and where there is warpage in some degree or more in the cover glass, there may occur brightness unevenness or Newton rings.

Accordingly, an object of the present invention is to provide a method for producing a glass sheet which can effectively suppress the warpage after chemical strengthening and which can omit or simplify polishing treatment or the like before chemical strengthening, and to provide the glass sheet obtained according to the production method and a chemically-strengthened glass sheet.

### Means for Solving Problems

The present invention is as mentioned in the following 1 to 15.

1. A method for producing a glass sheet, which is a method for producing a float glass sheet, containing a step of melting a glass source material, a step of forming the glass melted in the previous step into a glass ribbon while allowing it to float on a molten metal, and a step of annealing the glass ribbon, in which:

the float glass sheet contains (mol %) from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO, and

in the forming step, a top surface of the glass ribbon that is opposite to a bottom surface thereof to be in contact with the molten metal is subjected to a dealkalization treatment in the float bath for 1 to 30 seconds and a surface temperature of the glass ribbon during the dealkalization treatment is 600° C. or higher.

2. The method for producing a glass sheet according to the above 1, in which the dealkalization treatment is carried out with a mixed fluid.
3. The method for producing a glass sheet according to the above 2, in which the mixed fluid is a mixed fluid of hydrochloric acid and hydrofluoric acid.
4. A glass sheet, which is a float glass sheet containing (mol %) from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO, in which:

a ratio [(α−β)/γ] of a difference (α−β) between a surface Na₂O amount (α) in a top surface of the glass sheet and a surface Na₂O amount (β) in a bottom surface of the glass sheet to an Na₂O amount (γ) at a depth of 50 μm from the top surface is less than 0.02.

5. The glass sheet according to the above 4, in which the ratio [(α−β)/γ] of the difference (α−β) between the surface Na₂O amount (α) in the top surface and the surface Na₂O amount (β) in the bottom surface to the Na₂O amount (γ) at a depth of 50 μm from the top surface is less than 0.01.
6. The glass sheet according to the above 4 or 5, in which the ratio [(α−β)/γ] of the difference (α−β) between the surface Na₂O amount (α) in the top surface and the surface Na₂O amount (β) in the bottom surface of to the Na₂O amount (γ) at a depth of 50 μm from the top surface is −0.07 or more.
7. The glass sheet according to any one of the above 4 to 6, which has a thickness of 1.5 mm or less.
8. The glass sheet according to any one of the above 4 to 7, which has a thickness of 0.8 mm or less.
9. A chemically-strengthened glass sheet obtained through chemical strengthening of the glass sheet of any one of the above 4 to 8.
10. A chemically-strengthened glass sheet containing (mol %) from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO, in which:

a ratio [(x−y)/z] of a difference (x−y) between a surface K₂O amount (x) in a top surface of the glass sheet and a surface K₂O amount (y) in a bottom surface of the glass sheet to a K₂O amount (z) at a depth of 50 μm from the top surface is less than 0.66.

11. The chemically-strengthened glass sheet according to the above 10, in which the ratio [(x−y)/z] of the difference between the surface K₂O amount (x) in the top surface and the surface K₂O amount (y) in the bottom surface to the K₂O amount (z) at a depth of 50 μm from the top surface is 0.65 or less.
12. The chemically-strengthened glass sheet according to the above 10 or 11, in which the ratio [(x−y)/z] of the difference between the surface K₂O amount (x) in the top surface and the surface K₂O amount (y) in the bottom surface to the K₂O amount (z) at a depth of 50 μm from the top surface is −4.79 or more.
13. The chemically-strengthened glass sheet according to any one of the above 9 to 12, which has a thickness of 1.5 mm or less.
14. The chemically-strengthened glass sheet according to any one of the above 9 to 13, which has a thickness of 0.8 mm or less.
15. A flat panel display device equipped with a cover glass, in which the cover glass is the chemically-strengthened glass sheet of any one of the above 9 to 14.

### Advantageous Effects of Invention

The glass sheet obtained according to the production method of the present invention is dealkalized on one side thereof, in which, therefore, it is possible to prevent the occurrence of a difference in the degree of chemical strengthening between one surface of the glass and the other surface thereof, and without reducing the stress by chemical strengthening, and even though a polishing treatment or the like before the chemical strengthening is simplified or omitted, the warpage of the glass after chemical strengthening can be reduced and an excellent flatness degree can be obtained.

In addition, since the dealkalization treatment in a float bath, or that is, the on-line dealkalization treatment can be carried out within a short period of time, not only the glass productivity is improved but also glass that is improved in warpage can be obtained without causing deformation or distortion during treatment.

### BRIEF DESCRIPTION OF DRAWINGS

FIG. 1 is a view schematically illustrating a two-way injector employable in the present invention.

FIG. 2 is a view schematically illustrating a one-way injector employable in the present invention.

FIG. 3 is a cross-sectional view of a flat panel display, in which the float glass for chemical strengthening of the present invention is chemically strengthened and then used as the cover glass for the flat panel display.

FIG. 4(a) illustrates a schematic explanatory view of a method of treating a surface of a glass ribbon by supplying a gas that contains a molecule for dealkalization treatment in the structure thereof as a beam in a production of a glass sheet according to a float method. (b) of FIG. 4 is an A-A cross-sectional view of (a) of FIG. 4.

FIG. 5 (a) to (d) each illustrates a cross-sectional view of a beam, in which the amount of the gas can be controlled by dividing into 3 portions in the width direction of the glass ribbon.

### MODE FOR CARRYING OUT THE INVENTION

### 1. Production Method for Glass Sheet

The present invention is a method for producing a float glass sheet, which contains a step of melting a glass source material, a step of forming the glass melted in the previous step into a glass ribbon while allowing it to float on a molten metal, and a step of annealing the glass ribbon, and in which the float glass sheet is a soda lime silicate glass, and in the forming step, the top surface of the glass ribbon that is opposite to the bottom surface thereof to be in contact with the molten metal is dealkalized in the float bath for 1 to 30 seconds and the surface temperature of the glass ribbon during the dealkalization treatment is 600° C. or higher.

In the present invention, the glass ribbon of molten glass is formed into a tabular glass sheet according to a float method. So far as having a composition capable of being strengthened through chemical strengthening treatment, the glass of any of various soda lime silicate glass compositions can be used. Concretely, moderate amounts of various source materials are blended, then heated and melted, and thereafter homogenized by defoaming, stirring or the like, formed into a sheet according to a well-known float method, annealed, cut into a desired size, and polished for production. The glass produced according to the float method in the present invention is preferred as capable of readily exhibiting the improvement of warpage after chemical strengthening, as compared with the glass produced according to any other process of a down draw process, a press process or the like.

Regarding the glass sheet obtained according to the production method of the present invention, a glass sheet of soda lime silicate glass is used. The soda lime silicate glass contains, as mol % expression, from 50 to 80% of SiO₂, from 0.1 to 25% of Al₂O₃, from 3 to 30% of Li₂O+Na₂O+K₂O, from 0 to 25% of MgO, from 0 to 25% of CaO, and from 0 to 5% of ZrO₂. Above all, more preferred is glass that contains from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO. Here, for example, “containing from 0 to 1.5% of K₂O” means that K₂O is not indispensable but may be contained in an amount of up to 1.5%.

Not specifically defined, the thickness of the resultant glass sheet may be, for example, 2 mm, 0.8 mm, 0.73 mm, 0.7 mm, 0.56 mm or 0.4 mm. For effectively attaining the chemical strengthening treatment to be mentioned below, in general, the thickness is preferably 5 mm or less, more preferably 3 mm or less, even more preferably 1.5 mm or less, and still more preferably 0.8 mm or less.

In the production method for the glass sheet of the present invention, the top surface of the glass ribbon in the float method is dealkalized to remove the alkali component therefrom.

The surface temperature of the glass ribbon in the dealkalization treatment is 600° C. or higher since the treatment is carried out in a float bath, and is preferably from (Tg+50)° C. to (Tg+460)° C. relative to the glass transition temperature Tg thereof, more preferably from (Tg+50)° C. to (Tg+300)° C., and even more preferably from (Tg+50)° C. to (Tg+200)° C., from the viewpoint of the dealkalization.

The surface temperature of the glass ribbon may be controlled by changing the dealkalization treatment position or changing the heater power in the bath.

The time for the dealkalization treatment is from 1 to 30 seconds, and is preferably from 1 to 5 seconds from the viewpoint of the productivity.

As the dealkalization treatment for glass, there is mentioned a method of treatment with a liquid or a gas that provides ion exchange reaction with an alkali component in a glass ribbon (JP-T 7-507762). Glass ribbon may be hereinafter simply referred to as glass.

The liquid or gas that provides ion exchange reaction with an alkali component in glass includes, for example, a gas or a liquid that contains a molecule with a fluorine atom existing in the structure thereof, as well as a gas or a liquid of sulfur or a compound thereof, a chloride, an acid, or a nitride.

The gas or liquid that contains a molecule with a fluorine atom existing in the structure thereof includes, for example, hydrogen fluoride (HF), CFC chemicals (e.g., chlorofluorocarbon, fluorocarbon, hydrochlorofluorocarbon, hydrofluorocarbon, halons, etc.), hydrofluoric acid, fluorine elemental substance, trifluoroacetic acid, carbon tetrafluoride, silicon tetrafluoride, phosphorus pentafluoride, phosphorus trifluoride, boron trifluoride, nitrogen trifluoride, chlorine trifluoride, etc.

The gas or liquid of sulfur or a compound thereof, or a chloride includes sulfurous acid, sulfuric acid, peroxomonosulfuric acid, thiosulfuric acid, dithionous acid, disulfuric acid, peroxodisulfuric acid, polythionic acid, hydrogen sulfide, sulfur dioxide, sulfur trioxide, etc.

The acid includes hydrochloric acid, carbonic acid, boric acid, lactic acid, etc.

The nitride includes nitric acid, nitrogen monoxide, nitrogen dioxide, nitrous oxide, etc.

These are not limited to gas or liquid ones.

Of those, preferred are hydrochloric acid, hydrogen fluoride, CFC chemicals or hydrofluoric acid, as having high reactivity with the surface of a glass sheet. Of those gases, two or more may be combined for use herein. More preferred is a mixture of two or more types of acids (mixed fluid), as capable of increasing the dealkalization amount.

The mixed fluid includes a mixture of HCl and HF, a mixture of SO₃ and HF, a mixture of CO₂ and HF, etc. Above all, more preferred is a mixture fluid of hydrochloric acid and hydrogen fluoride. Regarding the blend ratio of hydrochloric acid and hydrofluoric acid, preferred is HCl:HF=1:0.02 to 1:4 (mol ratio), more preferred is 1:0.02 to 1:2 (mol ratio).

In the float bath, it is desirable not to use a fluorine elemental substance since the oxidation power thereof is too strong.

In the case where a liquid is used for the dealkalization treatment, the liquid may be applied to the surface of the glass sheet as it is, for example, by spraying, or the liquid may be vaporized and then applied to the surface of the glass sheet. If desired, it may be diluted with any other liquid or gas.

The liquid or gas that provides ion exchange reaction with an alkali component in glass may contain any other liquid or gas than that liquid or gas, and the additional liquid or gas is preferably a liquid or gas which does not react with that liquid or gas that provides ion exchange reaction with an alkali component in glass, at room temperature, from the viewpoint of stable dealkalization treatment.

The liquid or gas includes, for example, H₂O, N₂, air, H₂, O₂, Ne, Xe, CO₂, Ar, He, Kr, etc., which, however, are not limitative. Of those gases, two or more may be mixed and used.

As the carrier gas for the gas that provides ion exchange reaction with an alkali component in glass, preferably used is an inert gas such as N₂ or argon. For the gas that contains a molecule with a fluorine atom existing in the structure thereof, SO₂ may further be contained. SO₂ is used in continuously producing a glass sheet according to a float method or the like, and acts to prevent the glass sheet from having defects owing to contact thereof with a conveyor roller in the annealing area. In addition, a gas which decomposes at a high temperature may be contained.

Further, the liquid or gas that provides ion exchange reaction with an alkali component in glass may contain water vapor or water. Water vapor may be taken out by bubbling heated water with an inert gas such as nitrogen, helium, argon, or carbon dioxide. In a case where a large amount of water vapor is necessary, employable is a method of direct vaporization by introducing water into a vaporizer.

In the float method, which is a method of forming molten glass into a tabular glass sheet in the present invention, a glass sheet is produced by using a glass producing apparatus that containing a melting furnace of melting a glass source material, a float bath where the molten glass is floated on a molten metal (tin, etc.) to form a glass ribbon, and an annealing furnace where the glass ribbon is annealed.

In forming glass on the molten metal (tin) bath, a liquid or gas that provides ion exchange reaction with an alkali component in glass may be applied to the glass sheet being conveyed on the molten metal bath from the side (top surface) not in contact with the metal surface for treating that surface of the glass sheet. In the annealing region next to the molten metal (tin) bath, the glass sheet is conveyed by roller conveying.

Here, the annealing region includes not only the inside of the annealing furnace but also the part where the glass sheet is conveyed out of the molten metal (tin) bath inside the float bath and is conveyed into the annealing furnace. In the annealing region, the gas may be applied from the side (top surface) not in contact with the molten metal (tin).

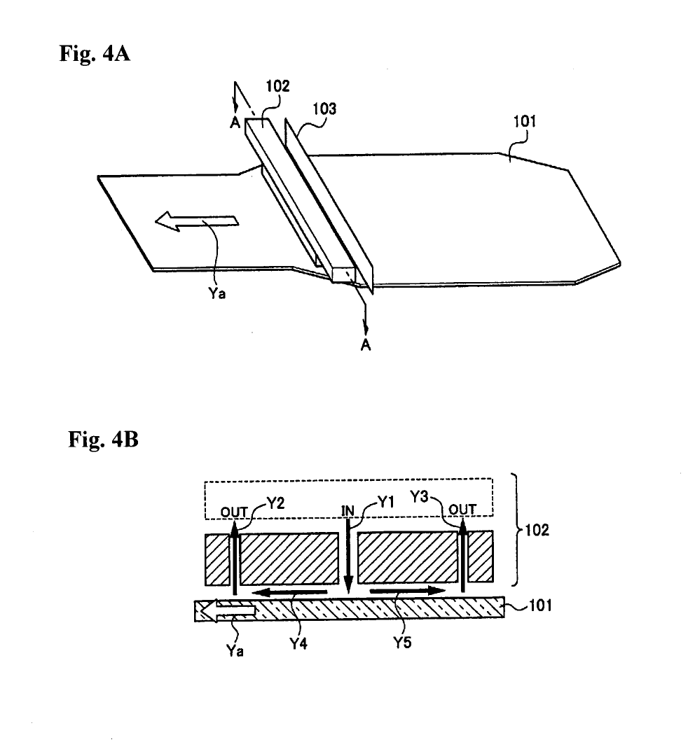

(a) of FIG. 4 illustrates a schematic explanatory view of a method for dealkalization treatment of the top surface of a glass surface in production of a glass sheet according to a float method.

In a float bath where molten glass is floated on a molten metal (tin, etc.) to form a glass ribbon 101, a gas that contains a molecule with a fluorine atom existing in the structure thereof is sprayed onto the glass ribbon 101 via the beam 102 inserted into the float bath. As illustrated in (a) of FIG. 4, it is desirable that the gas is sprayed onto the glass ribbon 101 from the side (top surface) where the glass ribbon 101 is not in contact with the molten metal surface. The arrow Ya indicates the direction in which the glass ribbon 101 flows in the float bath.

The position at which the gas is sprayed to the glass ribbon 101 via the beam 102 is, in the case where the glass transition point is 550° C. or higher, preferably a position at which the glass ribbon 101 is at a temperature of from (Tg+50)° C. to (Tg+460)° C., more preferably from (Tg+50)° C. to (Tg+300)° C., even more preferably from (Tg+50)° C. to (Tg+200)° C., and typically 600° C. The preferred glass ribbon temperature varies depending on the type of the gas to be sprayed.

The position of the beam 102 may be upstream or downstream the radiation gate 103. The amount of the gas to be sprayed onto the glass ribbon 101 is, in the case of HCl, preferably from 3×10⁻⁴ to 6×10⁻³ mol/glass ribbon 1 cm². In a case where the mixed fluid of HCl:HF of 1:1 (mol ratio) is used, the amount thereof is preferably from 6×10⁻⁴ to 1.9×10⁻³ mol/glass ribbon 1 cm².

(b) of FIG. 4 is an A-A cross-sectional view of (a) of FIG. 4. The gas sprayed onto the glass ribbon 101 in the direction Y1 through the beam 102 flows in from “IN” and flows out in the direction of “OUT”. In other words, it moves in the directions of arrows Y4 and Y5, and therefore, the glass ribbon 101 is exposed to the gas. In addition, the gas having run in the direction of the arrow Y4 flows out in the direction of the arrow Y2, while the gas having run in the direction of the arrow Y5 flows out in the direction of the arrow Y3.

Depending on the position of the glass ribbon 101 in the width direction thereof, the warpage amount of the glass sheet after chemical strengthening may change as the case may be, and in such a case, it is desirable that the amount of the gas is controlled. In other words, it is desirable that, to the position at which the warpage amount may be large, the amount of the gas to be sprayed is increased, while to the position at which the warpage amount may be small, the amount of the gas to be sprayed is reduced.

In the case where the warpage amount of the glass sheet after chemical strengthening may vary depending on the position of the glass ribbon 101, the structure of the beam 102 may be so designed that the amount of the gas could be controllable in the width direction of the glass ribbon 101 so that the warpage amount could be controlled in the width direction of the glass ribbon 101.

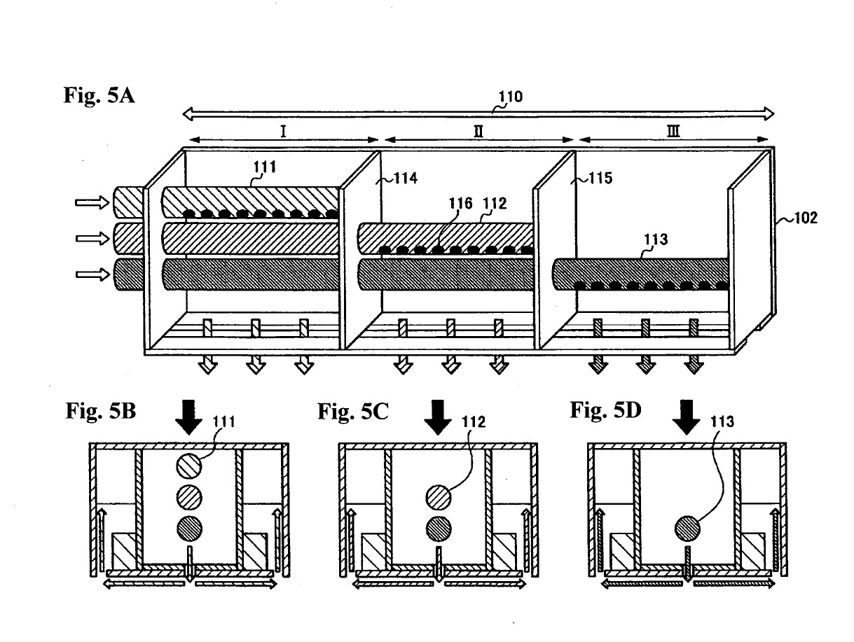

As one concrete example, (a) of FIG. 5 illustrates a cross-sectional view of the beam 102 via which the amount of the gas is controlled by dividing the width direction 110 of the glass ribbon 101 into three portions I to III. The gas lines 111 to 113 are divided by the partitions 114 and 115, and the gas is flowed out through the gas spray holes 116 of each line, and is thus sprayed onto the glass.

In (a) of FIG. 5, arrows indicate the flow of the gas. In (b) of FIG. 5, arrows indicate the flows of the gas through the gas line 111. In (c) of FIG. 5, arrows indicate the flows of the gas through the gas line 112. In (d) of FIG. 5, arrows indicate the flows of the gas through the gas line 113.

As a method of applying the liquid or gas that provides ion exchange reaction with an alkali component in glass, to the glass surface, for example, there may be mentioned a method of using an injector, a method of using an introduction tube, etc.

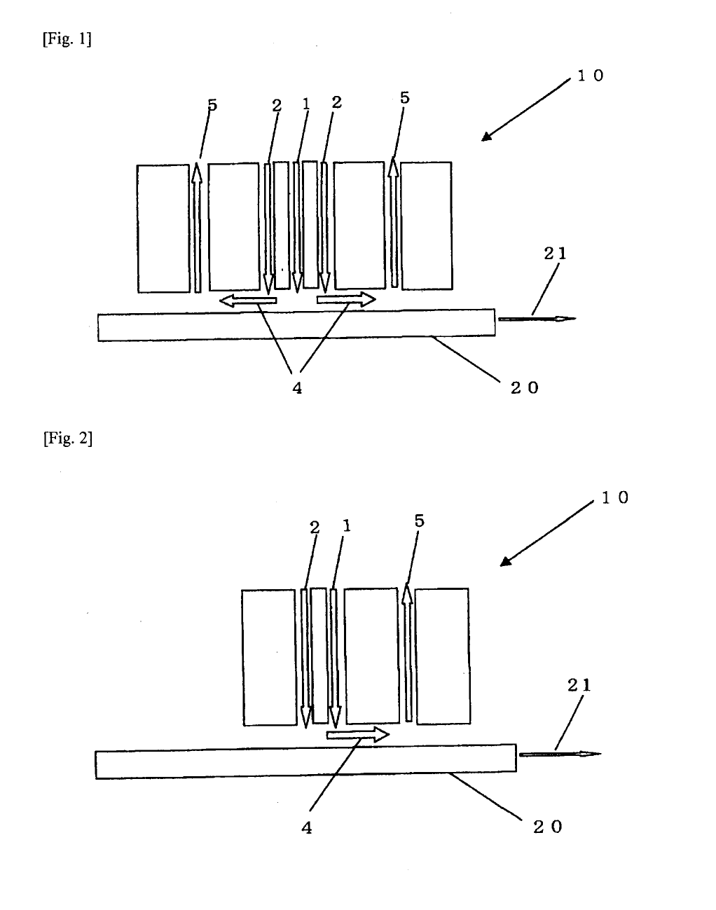

FIG. 1 and FIG. 2 each illustrate a schematic view of an injector employable in the present invention. FIG. 1 is a view schematically illustrating a two-way injector. FIG. 2 is a view schematically illustrating a one-way injector.

The gas or liquid that contains a molecule with a fluorine atom existing in the structure thereof is injected toward the glass sheet 20 via the center slit 1 and the outer slit(s) 2, then runs on the glass sheet 20 along the flow path 4, and is ejected out through the ejection slit 5. In FIG. 1 and FIG. 2, the reference number 21 indicates the direction in which the glass sheet 20 runs, and this is parallel to the flow path 4.

In the case where the “liquid or gas that provides ion exchange reaction with an alkali component in glass” to be supplied by the injector is a gas, it is desirable that the distance between the gas injection port of the injector and the glass sheet is 50 mm or less.

When the distance is controlled to be 50 mm or less, then the gas can be prevented from diffusing in the float bath atmosphere and therefore a sufficient amount of the gas, relative to the desired gas amount, can reach the glass sheet. On the contrary, when the distance to the glass sheet is too short, and for example, when the glass sheet produced according to a float method is processed in an on-line mode, there may be a risk that the glass sheet and the injector may contact with each other owing to fluctuation of the glass ribbon.

In the case where the “liquid or gas that provides ion exchange reaction with an alkali component in glass” to be supplied by the injector is a liquid, there is not any specific limitation on the distance between the liquid injection port of the injector and the glass sheet, or that is, they may be arranged so that the glass sheet can be uniformly treated.

The injector may be used as any mode such as a two-way mode, a one-way mode or the like, and two or more may be arranged in series relative to the glass sheet flowing direction to treat the surface of the glass sheet. The two-way injector is, as illustrated in FIG. 1, an injector in which the gas flow from injection to ejection is uniformly divided into the forward direction and the backward direction relative to the glass sheet traveling direction.

The one-way injector is, as illustrated in FIG. 2, an injector in which the gas flow from injection to ejection is fixed in either of the forward direction or the backward direction relative to the glass sheet traveling direction. In the case where such a one-way injector is used, it is desirable that the gas flow direction on the glass sheet and the glass sheet traveling direction are the same from the viewpoint of the gas flow stability.

In addition, it is also desirable that the supply port for the liquid or gas that provides ion exchange reaction with an alkali component in glass, and the ejection port for the unreacted liquid or gas that provides ion exchange reaction with an alkali component in glass as well as the gas formed through reaction with the glass sheet or the gas formed through reaction of two or more types of gases of the liquid or gas that provides ion exchange reaction with an alkali component in glass are arranged on the same side relative to the glass sheet.

In the present invention, the surface temperature of the glass sheet in the process where a liquid or gas that provides ion exchange reaction with an alkali component in glass (a gas or liquid containing a molecule with a fluorine atom existing in the structure thereof, or a gas or liquid of a chloride or the like) is supplied to the surface of the traveling glass sheet for treating the surface thereof is, when the glass transition temperature of the glass sheet is Tg, preferably from (Tg+50)° C. to (Tg+460)° C., more preferably from (Tg+50)° C. to (Tg+300)° C., even more preferably from (Tg+50)° C. to (Tg+200)° C.

Irrespective of the above, the surface temperature of the glass sheet is preferably higher than 600° C.

The pressure of the glass sheet surface in the process where the liquid or gas that provides ion exchange reaction with an alkali component in glass is supplied to the surface of the glass sheet is preferably in an atmosphere of which the pressure range is from (atmospheric pressure−100) Pa to (atmospheric pressure+100) Pa, more preferably in an atmosphere of which the pressure range is from (atmospheric pressure−50) Pa to (atmospheric pressure+50) Pa.

Regarding the gas flow rate, herein exemplarily described is a case of using a mixed fluid of HF:HCl=1:1 (mol ratio) as the liquid or gas that provides ion exchange reaction with an alkali component in glass. In treating a glass sheet with the mixed fluid of HF and HCl, the larger the flow rate of the mixed fluid is, the greater the warpage improving effect in chemical strengthening treatment is, and thus this is preferred. In a case where the total gas flow rate is the same, the higher the HF concentration in the mixed gas is, the greater the warpage improving effect in chemical strengthening treatment is.

In a case where the total gas flow rate and the HF gas flow rate in the mixed gas are constant, the longer the time for treatment of the glass sheet is, the greater the warpage improving effect in chemical strengthening treatment is. For example, in a case where the surface of a glass sheet is treated with a liquid or gas that provides ion exchange reaction with an alkali component in the glass after the glass sheet has been heated, the warpage after chemical strengthening may be improved more effectively as the glass sheet traveling speed is lower.

Even in facilities where the total gas flow rate or the HF flow rate in a mixed gas could not be well controlled, the warpage after chemical strengthening can be improved by suitably controlling the glass sheet traveling speed.

However, in the production method using the float method of the present invention, the upper limit of the time for dealkalization treatment of the glass sheet (glass ribbon) is 30 seconds from the viewpoint of the productivity.

In the production method for a glass sheet of the present invention, the top surface of the glass ribbon is dealkalized in a float method to remove the alkali component so that the difference between the ratio of the surface Na₂O amount in the top surface to the Na₂O amount at the depth of 50 μm from the top surface, and the ratio of the surface Na₂O amount in the bottom surface to the Na₂O amount at the depth of 50 μm from the top surface is made to be lower than 0.02. Preferably, the difference is less than 0.01, and the lower limit thereof is preferably −0.07 or more.

That is, when the surface Na₂O amount in the top surface is referred to as “α”, the surface Na₂O amount in the bottom surface is as “β”, and the Na₂O amount at the depth of 50 μm from the top surface is as “γ”, [(α−β)/γ]<0.02 is preferable and −0.07≦[(α−β)/γ]<0.01 is more preferable. When the dealkalization is performed by using a mixed fluid, (α−β)/γ is more readily become less than 0.01 compared with a case of performing the dealkalization by using a single gas, and therefore this is preferred.

The surface Na₂O amount in the top surface or the bottom surface is a mean Na₂O amount measured with XRF at a depth of 3 μm from each surface, as described below.

For controlling the value of (α−β)/γ to fall within the above-mentioned range, the F atom concentration in the gas or liquid for use for the dealkalization treatment as well as the temperature and/or the time for the dealkalization treatment may be suitably controlled and thereby this can be achieved.

### 2. Glass Sheet

The warpage of a glass sheet after chemical strengthening occurs owing to the difference between the behavior of chemical strengthening on one surface of the glass sheet and on the other surface thereof. Concretely, in the case of float glass, the behavior of chemical strengthening differs between the glass surface (top surface) of the glass sheet not in contact with a molten metal such as a molten tin during float forming and the glass surface (bottom surface) being in contact with the molten metal, and therefore the glass sheet is warped after chemical strengthening.

According to the present invention, a dealkalization treatment is performed on the top surface under a predetermined condition in a float bath during float forming so that a glass can be obtained in which the warpage due to chemical strengthening of the resultant glass sheet is significantly improved. In addition, during the dealkalization treatment, the difference between the degree of dealkalization of the top surface and the degree of the dealkalization of the bottom surface, or that is, the difference in the surface Na₂O amounts is controlled to be not less than a specific range, whereby the amount of ion diffusion in the top surface and the bottom surface of the glass sheet is controlled and the behavior of the chemical strengthening on the top surface and the bottom surface is thereby equalized to realize a glass sheet improved in warpage. Consequently, in the glass sheet obtained according to the production method of the present invention, the warpage of the glass sheet after chemical strengthening can be reduced without controlling the strengthening stress or performing a treatment such as grinding or polishing before the chemical strengthening treatment.

In addition, since the dealkalization treatment is performed in the float bath during float forming, the glass sheet productivity is increased. Further, since the dealkalization treatment is carried out within a short period of time of from 1 to 30 seconds, such a situation can be prevented that the resultant glass would be deformed or would be distorted owing to temperature unevenness.

In a case where the alkali component is Na, the dealkalization phenomenon of the glass surface contains a repetition of the following three stages (a), (b) and (c) in that order.

(a) Transportation of the alkali component from inside glass to the glass surface (exchange reaction between Na⁺ and H⁺ inside glass).

(b) Exchange reaction between Na⁺ and H⁺ in the glass surface.

(c) Removal of Na⁺ that has been exchanged for H⁺, from the glass surface.

The degree of dealkalization in the surface of glass can be evaluated by measuring the Na₂O amount therein. In the present invention, the Na₂O amount in glass is evaluated with XRF (X-ray fluorescence spectrometer) using Na—Kα ray.

The analysis condition in the XRF (X-ray fluorescence spectrometry) method is as mentioned below. The quantification is carried out according to a calibration curve method by using an Na₂O standard sample. As the measurement apparatus, there is mentioned ZSX PrimusII manufactured by Rigaku Corporation.

Output: Rh 50 kV-60 mA

### Filter: OUT

### Attenuator: 1/1

### Slit: S4.

### Dispersive Crystal: RX25

### Detector: PC

### Peak Angle (2θ/deg.): 46.800

Peak Measurement Time (second): 30

### PHA: 100-500

As described above, in the glass sheet of the present invention, when the surface Na₂O amount in the top surface is referred to as “α”, the surface Na₂O amount in the bottom surface is as “β”, and the Na₂O amount at 50 μm from the top surface is as “γ”, [(α−β)/γ]<0.02 is preferable and −0.07≦[(α−β)/γ]<0.01 is more preferable. In the glass sheet of the present invention of which the value (α−β)/γ falls within the above range, the warpage during chemical strengthening can be reduced.

When the value (α−β)/γ is 0.02 or more, the effect of reducing warpage is poor.

### 3. Chemical Strengthening

The chemical strengthening is a treatment of forming a compressive stress layer on the glass surface through ion exchange of exchanging an alkali metal ion having a small ion radius (typically, Li ion or Na ion) on the glass surface for an alkali ion having a larger ion radius (typically K ion) at a temperature not higher than the glass transition temperature thereof. The chemical strengthening treatment may be carried out according to a conventionally-known method.

The chemically-strengthened glass sheet of the present invention is chemically-strengthened glass to be obtained through chemically strengthening the soda lime silicate glass obtained according to the above-mentioned production method, and is a glass sheet that has been improved in warpage.

The value calculated by dividing the difference (ΔK₂O) between the surface K₂O amount in the top surface and the K₂O amount in the bottom surface after chemical strengthening treatment by the K₂O amount at the depth of 50 μm from the top surface is preferably less than 0.66, and more preferably 0.65 or less. It is indicated that the smaller this value is, the smaller the warpage after chemical strengthening treatment is. The lower limit of the value is preferably −4.79 or more.

That is, when the surface K₂O amount in the top surface is referred to as “x”, the surface K₂O amount in the bottom surface is as “y”, and the K₂O amount at the depth of 50 μm from the top surface is as “z”, [(x−y)/z]<0.66 is preferable, [(x−y)/z]≦0.65 is more preferable, and −4.79≦[(x−y)/z]≦0.65 is even more preferable.

The change of warpage (warpage change) of the glass sheet after chemical strengthening relative to the glass sheet before chemical strengthening may be determined by NIDEK CO., LTD. (Flatness Tester FT-17). The surface K₂O amount in the top surface or the bottom surface is a mean K₂O amount measured with XRF as described below, at a depth of 10 μm from each surface.

In the present invention, the improvement in warpage after chemical strengthening is evaluated by the warpage improvement rate to be determined according to the formula mentioned below, in the experiments under the same conditions except that the dealkalization treatment with a liquid or gas that provides ion exchange reaction with an alkali component in glass is performed.

Warpage Improvement Rate(%)=[1−(ΔY/ΔX)]×100

ΔX: the warpage change by chemical strengthening of an undealkalized glass sheet

ΔX: the warpage change by chemical strengthening of a dealkalized glass sheet

Here, the warpage change is ΔX>0. ΔY is, when the glass sheet is warped in the same direction as that of ΔX, ΔY>0, but when warped in the opposite direction to ΔX, ΔY<0.

Of the glass sheet not dealkalized with a liquid or gas that provides ion exchange reaction with an alkali component in glass, ΔX=ΔY, and the warpage improvement rate is 0%. In a case where ΔY is a negative value, the warpage improvement rate is more than 100%.

The thickness of the chemically-strengthened glass sheet obtained is not specifically defined. For example, the thickness is 2 mm, 0.8 mm, 0.73 mm, 0.7 mm, 0.56 mm, or 0.4 mm. For weight reduction, in general, the thickness is preferably 5 mm or less, more preferably 3 mm or less, even more preferably 1.5 mm or less, and still more preferably 0.8 mm or less.

### 4. Flat Panel Display Device

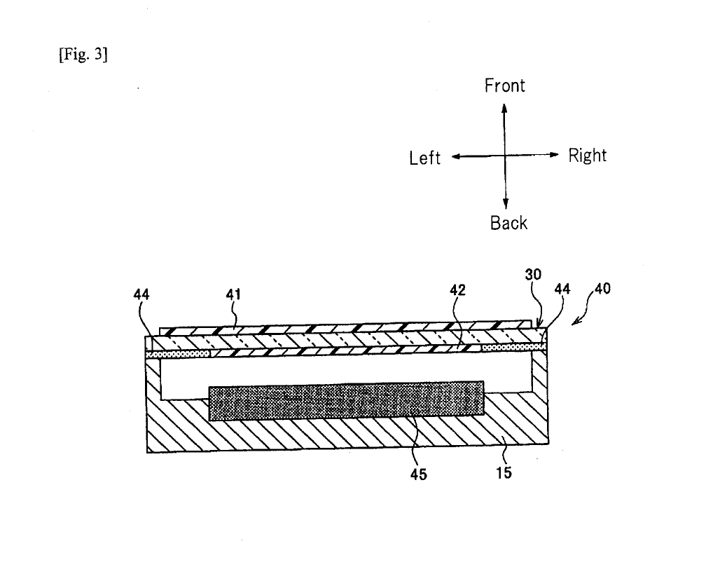

Described is a case where the glass sheet of the present invention is chemically strengthened and the chemically-strengthened glass sheet is used as a cover glass in a flat panel display device. FIG. 3 is a cross-sectional view of the display device with the cover glass arranged therein. In the following description, the front, bask, left and right are based on the directions of the arrows in the drawing.

As illustrated in FIG. 3, a display device 40 includes a display panel 45 provided in a housing 15 and a cover glass 30 provided to cover the entire surface of the display panel 45 and surround the front of the housing 15.

The cover glass 30 is disposed mainly for the purpose of improving the beauty and strength of the display device 40, preventing the impact damage and the like and is formed from one tabular glass having a whole shape of nearly planer shape. As illustrated in FIG. 3, the cover glass 30 may be disposed to be spaced (to have an air layer) from the display side (front side) of the display panel 45 or may be attached to the display side of the display panel 45 with an adhesive film (not shown) having translucency.

On the front surface of the cover glass 30, which emits light from the display panel 45, a functional film 41 is provided, and on the back surface where light from the display panel 45 enters, a functional film 42 is provided at a position corresponding to the display panel 45. In FIG. 3, functional films 41 and 42 are provided on both surfaces, but not limited thereto, and they may be provided on the front surface or back surface or may be omitted.

The functional films 41 and 42 have a function, for example, of preventing reflection of surrounding light, preventing impact damage, shielding electromagnetic wave, shielding near infrared ray, correcting color tone, and/or enhancing scratch resistance, and the thickness, shape, etc. are appropriately selected according to usage. The functional films 41 and 42 are formed, for example, by attaching a resin-made film to the cover glass 30. Alternatively, they may be formed by a thin film formation method such as deposition method, sputtering method or CVD method.

The reference numeral 44 is a black layer and is, for example, a coating film formed by applying an ink containing a pigment particle on the cover glass 30 and subjecting it to ultraviolet irradiation or heating/firing and then cooling. The display panel, etc. is made invisible from the outside of the housing 15 and thereby the aesthetics of appearance is enhanced.

### EXAMPLES

Examples of the present invention are described concretely hereinunder, but the present invention is not limited to these.

### (Composition of Glass Sheet)

In Examples, a glass sheet of a glass material A having the composition mentioned below was used.

(Glass Material A) Glass containing, as mol %, 72.0% of SiO₂, 1.1% of Al₂O₃, 12.6% of Na₂O, 0.2% of K₂O, 5.5% of MgO and 8.6% of CaO (glass transition temperature 566° C.).

### (Measurement of Warpage)

Before chemical strengthening, the warpage amount was measured by using NIDEK CO., LTD. (Flatness Tester FT-17). After each glass was chemically strengthened, the warpage amount after chemical strengthening was measured in the same manner and Δwarpage was calculated as represented by the following formula. ΔWarpage amount=warpage amount after chemical strengthening−warpage amount before chemical strengthening

### (Warpage Improvement Rate)

Improvement in warpage after chemical strengthening was evaluated by the warpage improvement rate to be determined according to the formula mentioned below, in the experiments carried out under the same conditions except that the dealkalization treatment with a liquid or gas capable of providing ion exchange reaction with an alkali component in glass was performed.

Warpage Improvement Rate(%)[1−(ΔY/ΔX)]×100

ΔX: the warpage change by chemical strengthening of an untreated glass sheet

ΔY: the warpage change by chemical strengthening of a treated glass sheet.

Here, the warpage change was ΔX>0. ΔY was, when the glass sheet was warped in the same direction as that of ΔX, ΔY>0, but when warped in the opposite direction to ΔX, ΔY<0.

### (XRF Method)

The measurement analysis condition of the Na₂O amount according to XRF (X-ray fluorescence spectrometry) method was as follows. The quantification was carried out according to a calibration curve method by using an Na₂O standard sample.

Measurement Apparatus: ZSX PrimusII manufactured by Rigaku Corporation
Output: Rh 50 kV-60 mA

### Filter: OUT

### Attenuator: 1/1

### Slit: S4

### Dispersive Crystal: RX25

### Detector: PC

### Peak Angle (2θ/deg.): 46.800

Peak Measurement Time (second): 30

### PHA: 100-500

The measurement analysis condition of the K₂O amount according to XRF was as follows. The ion exchange amount is the value calculated by subtracting the K₂O analysis value before chemical strengthening (raw sheet) from the K₂O analysis value after chemical strengthening.

Measurement Apparatus: ZSX PrimusII manufactured by Rigaku Corporation
Output: Rh 50 kV-60 mA

### Filter: OUT

### Attenuator: 1/1

### Slit: S4

### Dispersive Crystal: LiF (200)

### Detector: PC

### Peak Angle (2θ/deg.): 136.650

Peak Measurement Time (second): 30

### PHA: 100-300

### (Measurement of Surface Compressive Stress: CS and Compressive Stress Depth: DOL)

CS and DOL of the obtained glass sheet after chemical strengthening were measured, by using a surface stress meter (FSM-6000LE) manufactured by Orihara Manufacturing CO., LTD.

### Examples 1-1 to 1-4, and Comparative Example 1-1

In a float bath in which a glass ribbon of the glass material A flows, dealkalization treatment with a gas containing HCl was performed under the treatment condition shown in Table 1.

The resultant glass sheet dealkalized with HCl or the undealkalized glass sheet was analyzed with XRF to measure the surface Na₂O amount in the top surface (treated surface) and the surface Na₂O amount in the bottom surface (non-treated surface). The treated surface (top surface) was polished by 50 μm, and the Na₂O amount in the polished surface was measured to be the Na₂O amount inside the glass. With that, the each ratio of the surface Na₂O amount in the treated surface (top surface) or the non-treated surface (bottom surface) to the Na₂O amount inside the glass was calculated. In addition, the ratio of the difference (ΔNa₂O amount) between the surface Na₂O amounts in the treated surface and in the non-treated surface to the Na₂O amount inside the glass was calculated.

The resultant glass sheet dealkalized with HCl or the undealkalized glass sheet was chemically strengthened with a molten salt of potassium nitrate at 420° C. for 150 minutes, and each of CS in the top surface, DOL in the top surface, Δwarpage amount (warpage change), and the warpage improvement rate was determined. The thickness of the obtained chemically-strengthened glass sheet was 0.7 mm.

The glass sheet after chemical strengthening was analyzed with XRF to measure the surface K₂O amount in the top surface (treated surface) and the surface K₂O amount in the bottom surface (non-treated surface). The treated surface (top surface) was polished by 50 μm, and the K₂O amount in the polished surface was measured to be the K₂O amount inside the glass. With that, the each ratio of the surface K₂O amount in the treated surface (top surface) or the non-treated surface (bottom surface) to the K₂O amount inside the glass was calculated. In addition, the ratio of the difference (ΔK₂O amount) between the surface K₂O amounts in the treated surface and in the non-treated surface to the K₂O amount inside the glass was calculated. The K₂O amount before chemical strengthening was nearly the same in the treated surface and the non-treated surface, and therefore the above-mentioned ΔK₂O was referred to as the ion exchange amount difference here.

In regard to the surface Na₂O amount in the top surface and the bottom surface of the resultant glass sheet, each of the mean Na₂O amount at the depth of from 0 to 3 μm from the treated surface and from 0 to 3 μm from the non-treated surface was measured.

In regard to the surface K₂O amount in the top surface and the bottom surface after chemical strengthening, each of the mean K₂O amount at the depth of from 0 to 10 μm from the treated surface and from 0 to 10 μm from the non-treated surface was measured.

The condition for the dealkalization treatment and the physical properties of the obtained chemically-strengthened glass are shown in Table 1.

TABLE 1

| | Ex. 1-1 | Ex. 1-2 | Ex. 1-3 | Ex. 1-4 | Comp. Ex. 1-1 |
|---|---|---|---|---|---|
| Treatment Time (s) | 3.5 | | | | 3.5 |
| Treatment Temperature (° C.) | 752 | | | | 752 |
| HCl Concentration (%) | 5 | 7.5 | 10 | 20 | 0 |
| Linear Speed (cm/s) | 100 | | | | |
| Total HCl Contact Amount (mol/cm²) | 7.71E−04 | 1.16E−03 | 1.54E−03 | 3.09E−03 | 0.00E+00 |
| CS | 713.5 | 711.7 | 711.4 | 713.7 | 686.4 |
| DOL | 7.1 | 7.1 | 7.1 | 7.1 | 7.0 |
| Warpage Amount before Chemical Strengthening | 14.6 | 10.9 | 13.2 | 11.2 | 9.1 |
| Warpage Amount after Chemical Strengthening | 64.3 | 59.8 | 58.1 | 58.2 | 74.7 |
| ΔWarpage Amount | 49.7 | 48.9 | 44.9 | 47.0 | 65.6 |
| Warpage Improvement Rate (%) | 24.3% | 25.5% | 31.6% | 28.4% | 0.0% |
| Na₂O Amount in top surface/Na₂O Amount inside glass (—) | 0.99 | 0.99 | 0.99 | 0.99 | 1.00 |
| Na₂O Amount in bottom surface/Na₂O Amount inside glass | 0.98 | 0.98 | 0.98 | 0.98 | 0.98 |
| (—) | | | | | |
| ΔNa₂O Amount/(inside glass) (—) | 0.01 | 0.01 | 0.01 | 0.01 | 0.02 |
| K₂O Amount in top surface/K₂O Amount inside glass (—) | 20.7 | 20.7 | 20.6 | 20.6 | 20.4 |
| K₂O Amount in bottom surface/K₂O Amount inside glass (—) | 20.5 | 20.4 | 20.4 | 20.4 | 19.7 |
| ΔK₂O Amount/K₂O Amount inside glass (—) | 0.24 | 0.24 | 0.14 | 0.14 | 0.72 |

As shown in Table 1, it was found that, by performing the chemical strengthening after dealkalization treatment of the top surface with HCl for 3.5 seconds in the float bath, the glass sheet after the chemical strengthening was improved in warpage.

### Examples 2-1 to 2-11 and Comparative Example 2-1

In the same manner as in Example 1-1 except that the glass of the glass material A manufactured according to a float method is dealkalized with a mixed gas of HF and HCl, the physical properties of the resultant glass and the glass after chemical strengthening were measured. Comparative Example 2-1 is a glass without dealkalization treatment. The thickness of every obtained chemically-strengthened glass sheet was 0.7 mm.

The condition for the dealkalization treatment and the physical properties of the resultant glass and the chemically-strengthened glass are shown in Table 2.

TABLE 2

| | Ex. | Ex. | Ex. | Ex. | Ex. | Ex. | Ex. | Ex. | Ex. | Ex. | Ex. | Comp. |
|---|---|---|---|---|---|---|---|---|---|---|---|---|
| | 2-1 | 2-2 | 2-3 | 2-4 | 2-5 | 2-6 | 2-7 | 2-8 | 2-9 | 2-10 | 2-11 | Ex. 2-1 |
| Treatment Time (s) | 3.5 | | | | | | | | | | | — |
| Treatment Temperature (° C.) | 752 | | | | | | | | | | | — |
| HF Concentration (%) | 2 | 4 | 4 | 4 | 4 | 4 | 4 | 6 | 6 | 6 | 6 | 0 |
| HCl Concentration (%) | 2 | 1 | 2 | 4 | 8 | 12 | 20 | 3 | 6 | 12 | 18 | 0 |
| Linear Speed (cm/s) | 100 | | | | | | | | | | | |
| Total HF Contact Amount | 3.09 | 6.17 | 6.17 | 6.17 | 6.17 | 6.17 | 6.17 | 9.26 | 9.26 | 9.26 | 9.26 | 0.00 |
| (mol/cm²) | E−04 | E−04 | E−04 | E−04 | E−04 | E−04 | E−04 | E−04 | E−04 | E−04 | E−04 | E+00 |
| Total HCl Contact Amount | 3.09 | 1.54 | 3.09 | 6.17 | 1.23 | 1.85 | 3.09 | 4.63 | 9.26 | 1.85 | 2.78 | 0.00 |
| (mol/cm²) | E−04 | E−04 | E−04 | E−04 | E−03 | E−03 | E−03 | E−04 | E−04 | E−03 | E−03 | E+00 |
| CS | 706.3 | 650.9 | 655.6 | 673.4 | 676.2 | 674.2 | 659.5 | 621.0 | 647.6 | 628.3 | 631.1 | 725.7 |
| DOL | 7.0 | 6.4 | 6.3 | 6.2 | 6.3 | 6.2 | 6.2 | 6.3 | 6.2 | 6.1 | 6.1 | 7.1 |
| Warpage Amount before | 8.5 | −1.8 | 7.2 | 8.2 | 7.4 | 7.1 | 7.5 | 6.1 | 7.4 | 4.9 | 8.6 | 6.4 |
| Chemical Strengthening | | | | | | | | | | | | |
| Warpage Amount after | 1.1 | −51.6 | −63.7 | −61.7 | −73.3 | −71.1 | −68.6 | −129.8 | −140.4 | −156.1 | −168.9 | 69.7 |
| Chemical Strengthening | | | | | | | | | | | | |
| ΔWarpage Amount | −7.4 | −49.7 | −70.9 | −69.9 | −80.6 | −78.1 | −76.1 | −135.9 | −147.8 | −161.0 | −177.5 | 63.3 |
| Warpage Improvement Rate (%) | 111.7% | 178.5% | 211.9% | 210.4% | 227.4% | 223.4% | 220.2% | 314.6% | 333.4% | 354.3% | 380.3% | 0.0% |
| Na₂O Amount in top surface/ | 0.97 | 0.97 | 0.95 | 0.95 | 0.94 | 0.94 | 0.94 | 0.93 | 0.93 | 0.92 | 0.91 | 1.00 |
| Na₂O Amount inside glass (—) | | | | | | | | | | | | |
| Na₂O Amount in bottom | | | | | | | | | | | | |
| surface/Na₂O Amount inside | 0.98 | 0.98 | 0.98 | 0.98 | 0.98 | 0.98 | 0.98 | 0.98 | 0.98 | 0.98 | 0.98 | 0.98 |
| glass (—) | | | | | | | | | | | | |
| ΔNa₂O Amount/(inside glass) (—) | −0.01 | −0.02 | −0.03 | −0.03 | −0.04 | −0.05 | −0.04 | −0.05 | −0.06 | −0.07 | −0.07 | 0.02 |
| K₂O Amount in top surface/K₂O | 19.5 | 18.6 | 18.0 | 17.8 | 17.8 | 17.7 | 17.9 | 16.5 | 16.2 | 15.8 | 15.7 | 21.1 |
| Amount inside glass (—) | | | | | | | | | | | | |
| K₂O Amount in bottom | | | | | | | | | | | | |
| surface/K₂O Amount inside glass | 20.4 | 20.4 | 20.4 | 20.4 | 20.5 | 20.5 | 20.5 | 20.6 | 20.6 | 20.6 | 20.5 | 20.3 |
| (—) | | | | | | | | | | | | |
| ΔK₂O Amount/K₂O Amount | −0.90 | −1.79 | −2.45 | −2.66 | −2.72 | −2.76 | −2.62 | −4.10 | −4.34 | −4.72 | −4.79 | 0.76 |
| inside glass (—) | | | | | | | | | | | | |

As shown in Table 2, it was found that, by using a mixed gas of HF and HCl in the dealkalization treatment, the warpage after the chemical strengthening was greatly improved.

### Examples 3-1 to 3-13 and Comparative Example 3-1

In the same manner as in Example 1-1 except that the glass of the glass material A manufactured according to a float method was dealkalized at 647° C. for 3.5 seconds with the acid obtained by mixing acids as shown in Tables 3 and 4, the physical properties of the resultant glass and the chemically-strengthened glass were measured. Comparative Example 3-1 is a glass without dealkalization treatment. The thickness of every obtained chemically-strengthened glass sheet was 0.7 mm.

The condition for the dealkalization treatment and the physical properties of the resultant glass and the chemically-strengthened glass are shown in Tables 3 and 4.

TABLE 3

| | Ex. | Ex. | Ex. | Ex. | Ex. | Ex. | Ex. | Ex. | Ex. | Ex. |
|---|---|---|---|---|---|---|---|---|---|---|
| | 3-1 | 3-2 | 3-3 | 3-4 | 3-5 | 3-6 | 3-7 | 3-8 | 3-9 | 3-10 |
| Treatment Time (s) | 3.5 | | | | | | | | | |
| Treatment Temperature (° C.) | 647 | | | | | | | | | |
| HF Concentration (%) | 0 | 0 | 0 | 0 | 0 | 0 | 0.3 | 1 | 2 | 0.3 |
| HCl Concentration (%) | 2 | 10 | 20 | 38.8 | 10 | 10 | 2 | 2 | 2 | 20 |
| Linear Speed (crn/s) | 100 | 100 | 100 | 100 | 50 | 75 | 100 | 100 | 100 | 100 |
| Total HF Contact Amount (mol/cm²) | 0.00 | 0.00 | 0.00 | 0.00 | 0.00 | 0.00 | 4.63 | 1.54 | 3.09 | 4.63 |
| | E+00 | E+00 | E+00 | E+00 | E+00 | E+00 | E−05 | E−04 | E−04 | E−05 |
| Total HCI Contact Amount (mol/cm²) | 3.09 | 1.54 | 3.09 | 5.99 | 7.71 | 1.16 | 3.09 | 3.09 | 3.09 | 3.09 |
| | E−04 | E−03 | E−03 | E−03 | E−04 | E−03 | E−04 | E−04 | E−04 | E−03 |
| CS | 721.5 | 720.7 | 713.0 | 726.6 | 706.8 | 698.9 | 727.2 | 703.6 | 694.9 | 711.3 |
| DOL | 7.0 | 7.0 | 7.0 | 7.0 | 7.1 | 7.0 | 7.0 | 6.3 | 6.2 | 7.0 |
| Warpage Amount before Chemical | 10.0 | 9.7 | 8.2 | 4.6 | 9.4 | 16.1 | 12.8 | 10.0 | 8.7 | 10.2 |
| Strengthening | | | | | | | | | | |
| Warpage Amount after Chemical | 60.7 | 52.6 | 45.3 | 34.9 | 63.5 | 66.9 | 47.1 | 13.9 | −28.8 | 34.5 |
| Strengthening | | | | | | | | | | |
| ΔWarpage Amount | 50.7 | 42.8 | 37.2 | 30.3 | 54.1 | 50.8 | 34.3 | 3.9 | −37.5 | 24.3 |
| Warpage Improvement Rate (%) | 20.3% | 32.7% | 41.6% | 52.3% | 14.9% | 20.2% | 46.2% | 93.9% | 159.0% | 61.8% |
| Na₂O Amount in top surface/ Na₂O | 0.99 | 0.99 | 0.98 | 0.98 | 0.98 | 0.98 | 0.98 | 0.97 | 0.96 | 0.98 |
| Amount inside glass (—) | | | | | | | | | | |
| Na₂O Amount in bottom surface/Na₂O | 0.98 | 0.98 | 0.98 | 0.98 | 0.98 | 0.98 | 0.98 | 0.98 | 0.98 | 0.98 |
| Amount inside glass (—) | | | | | | | | | | |
| ΔNa₂O Amount/(inside glass) (—) | 0.01 | 0.01 | 0.00 | 0.00 | 0.01 | 0.00 | 0.00 | −0.01 | −0.02 | 0.00 |
| K₂O Amount in top surface/K₂O | 20.5 | 20.3 | 20.2 | 20.0 | 20.4 | 20.3 | 20.1 | 19.5 | 18.8 | 19.7 |
| Amount inside glass (—) | | | | | | | | | | |
| K₂O Amount in bottom surface/K₂O | 20.3 | 20.3 | 20.3 | 20.3 | 20.2 | 20.3 | 20.3 | 20.3 | 20.4 | 20.2 |
| Amount inside glass (—) | | | | | | | | | | |
| ΔK₂O Amount/K₂O Amount inside | 0.24 | 0.00 | −0.14 | −0.28 | 0.21 | 0.00 | −0.17 | −0.83 | −1.59 | −0.48 |
| glass (—) | | | | | | | | | | |

TABLE 4

| | Ex. 3-11 | Ex. 3-12 | Ex. 3-13 | Comp. Ex. 3-1 |
|---|---|---|---|---|
| Treatment Time (s) | 3.5 | | | — |
| Treatment Temperature (° C.) | 647 | | | — |
| HF Concentration (%) | 0.5 | 1 | 2 | 0 |
| HCl Concentration (%) | 20 | 20 | 20 | 0 |
| Linear Speed (cm/s) | 100 | 100 | 100 | 100 |
| Total HF Contact Amount (mol/cm²) | 7.71E−05 | 1.54E−04 | 3.09E−04 | 0.00E+00 |
| Total HCl Contact Amount (mol/cm²) | 3.09E−03 | 3.09E−03 | 3.09E−03 | 0.00E+00 |
| CS | 704.9 | 697.1 | 676.6 | 725.2 |
| DOL | 6.3 | 6.3 | 6.2 | 7.1 |
| Warpage Amount before Chemical Strengthening | 10.2 | 9.3 | 10.4 | 9.5 |
| Warpage Amount after Chemical Strengthening | 25.5 | 8.3 | −43.5 | 73.1 |
| ΔWarpage Amount | 15.4 | −1.0 | −53.9 | 63.6 |
| Warpage Improvement Rate (%) | 75.9% | 101.5% | 184.8% | 0.0% |
| Na₂O Amount in top surface/Na₂O Amount inside glass (—) | 0.97 | 0.97 | 0.95 | 1.00 |
| Na₂O Amount in bottom surface/Na₂O Amount inside glass (—) | 0.98 | 0.98 | 0.98 | 0.98 |
| ΔNa₂O Amount/(inside glass) (—) | −0.01 | −0.01 | −0.03 | 0.02 |
| K₂O Amount in top surface/K₂O Amount inside glass (—) | 19.4 | 19.1 | 18.1 | 20.9 |
| K₂O Amount in bottom surface/K₂O Amount inside glass (—) | 20.1 | 20.2 | 20.4 | 20.2 |
| ΔK₂O Amount/K₂O Amount inside glass (—) | −0.69 | −1.14 | −2.31 | 0.69 |

### Examples 4-1 to 4-7, and Comparative Example 4-1

In the same manner as in Example 1-1 except that the glass of the glass material A manufactured according to a float method was dealkalized at 653° C. for 3.5 seconds with the acid as shown in Table 5, the physical properties of the resultant glass and the chemically-strengthened glass were measured. Comparative Example 4-1 is a glass without dealkalization treatment. The thickness of every obtained chemically-strengthened glass sheet was 0.7 mm.

The condition for the dealkalization treatment and the physical properties of the resultant glass and the chemically-strengthened glass are shown in Table 5.

TABLE 5

| | | | | | | | | Comp. |
|---|---|---|---|---|---|---|---|---|
| | Ex. 4-1 | Ex. 4-2 | Ex. 4-3 | Ex. 4-4 | Ex. 4-5 | Ex. 4-6 | Ex. 4-7 | Ex. 4-1 |
| Treatment Time (s) | 3.5 | | | | | | | — |
| Treatment Temperature (° C.) | 653 | | | | | | | — |
| HF Concentration (%) | 0 | 0 | 0 | 0.3 | 2 | 0.3 | 2 | 0 |
| HCl Concentration (%) | 2 | 10 | 20 | 2 | 2 | 20 | 20 | 0 |
| Linear Speed (cm/s) | 100 | | | | | | | |
| Total HF Contact Amount (mol/cm²) | 0 | 0 | 0 | 4.63E−05 | 3.09E−04 | 4.63E−05 | 3.09E−04 | 0 |
| Total HCl Contact Amount (mol/cm²) | 3.09E−04 | 1.54E−03 | 3.09E−03 | 3.09E−04 | 3.09E−04 | 3.09E−03 | 3.09E−03 | 0 |
| CS | 717.2 | 705.9 | 709.4 | 704.5 | 671.4 | 701.8 | 647.6 | 706.9 |
| DOL | 7.1 | 7.1 | 7.0 | 7.0 | 6.2 | 6.9 | 6.0 | 7.1 |
| Warpage Amount before Chemical | 11.5 | 10.9 | 10.9 | 11.7 | 5.9 | 13.0 | 2.7 | 10.3 |
| Strengthening | | | | | | | | |
| Warpage Amount after Chemical | 74.8 | 71.5 | 67.8 | 48.4 | −46.4 | 39.7 | −110.9 | 76.8 |
| Strengthening | | | | | | | | |
| ΔWarpage Amount | 63.3 | 60.6 | 56.9 | 36.6 | −52.3 | 26.7 | −113.6 | 66.6 |
| Warpage Improvement Rate (%) | 5.0% | 8.9% | 14.5% | 45.0% | 178.6% | 59.9% | 270.7% | 0.0% |
| Na₂O Amount in top surface/ Na₂O | 0.99 | 0.99 | 0.99 | 0.98 | 0.96 | 0.97 | 0.94 | 1.00 |
| Amount inside glass (—) | | | | | | | | |
| Na₂O Amount in bottom surface/Na₂O | 0.98 | 0.98 | 0.98 | 0.98 | 0.98 | 0.98 | 0.98 | 0.98 |
| Amount inside glass (—) | | | | | | | | |
| ANa₂O Amount/(inside glass) (—) | 0.01 | 0.01 | 0.01 | 0.00 | −0.02 | 0.00 | −0.04 | 0.02 |
| K₂O Amount in top surface/K₂O | 20.7 | 20.6 | 20.4 | 20.1 | 18.2 | 19.9 | 17.1 | 20.9 |
| Amount inside glass (—) | | | | | | | | |
| K₂O Amount in bottom surface/K₂O | 20.2 | 20.2 | 20.2 | 20.4 | 20.6 | 20.3 | 20.8 | 20.2 |
| Amount inside glass (—) | | | | | | | | |
| ΔK₂O Amount/K₂O Amount | 0.48 | 0.34 | 0.24 | −0.24 | −2.34 | −0.45 | −3.66 | 0.66 |
| inside glass (—) | | | | | | | | |

As shown in Tables 3 to 5, it was found that, by performing the dealkalization treatment at 647° C. or 653° C., the ratio of the difference between the K₂O amount in the top surface and the K₂O amount in the bottom surface to the K₂O amount inside the glass can be reduced and therefore the warpage can be improved.

While the present invention has been described in detail and with reference to specific embodiments thereof, it will be apparent to one skilled in the art that various changes and modifications can be made therein without departing from the intention and scope of the present invention. The present application is based on a Japanese patent application filed on Dec. 27, 2012 (Patent Application 2012-285511) and a Japanese patent application filed on Sep. 25, 2013 (Patent Application 2013-198470), the entire contents of which are incorporated herein by reference.

### DESCRIPTION OF REFERENCE NUMERALS AND SIGNS

1 CENTER SLIT
2 OUTER SLIT
4 FLOW PATH
5 EJECTION SLIT
15 HOUSING
20 GLASS SHEET
30 COVER GLASS
40 DISPLAY DEVICE
41, 42 FUNCTIONAL FILM
45 DISPLAY PANEL
101 GLASS RIBBON
102 BEAM
103 RADIATION GATE
110 WIDTH DIRECTION OF GLASS RIBBON
111, 112, 113 GAS LINE
114, 115 PARTITION
116 GAS SPRAY HOLE

1. A method for producing a glass sheet, which is a method for producing a float glass sheet, comprising a step of melting a glass source material, a step of forming the glass melted in the previous step into a glass ribbon while allowing it to float on a molten metal, and a step of annealing the glass ribbon, wherein:
the float glass sheet contains (mol %) from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO, and
in the forming step, a top surface of the glass ribbon that is opposite to a bottom surface thereof to be in contact with the molten metal is subjected to a dealkalization treatment in the float bath for 1 to 30 seconds and a surface temperature of the glass ribbon during the dealkalization treatment is 600° C. or higher.

2. The method for producing a glass sheet according to claim 1, wherein the dealkalization treatment is carried out with a mixed fluid.

3. The method for producing a glass sheet according to claim 2, wherein the mixed fluid is a mixed fluid of hydrochloric acid and hydrofluoric acid.

4. A glass sheet, which is a float glass sheet containing (mol %) from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO, wherein:
a ratio [(α−β)/γ] of a difference (α−β) between a surface Na₂O amount (α) in a top surface of the glass sheet and a surface Na₂O amount (β) in a bottom surface of the glass sheet to an Na₂O amount (γ) at a depth of 50 μm from the top surface is less than 0.02.

5. The glass sheet according to claim 4, wherein the ratio [(α−β)/γ] of the difference (α−β) between the surface Na₂O amount (α) in the top surface and the surface Na₂O amount (β) in the bottom surface to the Na₂O amount (γ) at a depth of 50 μm from the top surface is less than 0.01.

6. The glass sheet according to claim 4, wherein the ratio [(α−β)/γ] of the difference (α−β) between the surface Na₂O amount (α) in the top surface and the surface Na₂O amount (β) in the bottom surface of to the Na₂O amount (γ) at a depth of 50 μm from the top surface is −0.07 or more.

7. The glass sheet according to claim 4, which has a thickness of 1.5 mm or less.

8. The glass sheet according to claim 4, which has a thickness of 0.8 mm or less.

9. A chemically-strengthened glass sheet obtained through chemical strengthening of the glass sheet of claim 4.

10. A chemically-strengthened glass sheet comprising (mol %) from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO, wherein:
a ratio [(x−y)/z] of a difference (x−y) between a surface K₂O amount (x) in a top surface of the glass sheet and a surface K₂O amount (y) in a bottom surface of the glass sheet to a K₂O amount (z) at a depth of 50 μm from the top surface is less than 0.66.

11. The chemically-strengthened glass sheet according to claim 10, wherein the ratio [(x−y)/z] of the difference between the surface K₂O amount (x) in the top surface and the surface K₂O amount (y) in the bottom surface to the K₂O amount (z) at a depth of 50 μm from the top surface is 0.65 or less.

12. The chemically-strengthened glass sheet according to claim 10, wherein the ratio [(x−y)/z] of the difference between the surface K₂O amount (x) in the top surface and the surface K₂O amount (y) in the bottom surface to the K₂O amount (z) at a depth of 50 μm from the top surface is −4.79 or more.

13. The chemically-strengthened glass sheet according to claim 9, which has a thickness of 1.5 mm or less.

14. The chemically-strengthened glass sheet according to claim 9, which has a thickness of 0.8 mm or less.

15. A flat panel display device equipped with a cover glass, wherein the cover glass is the chemically-strengthened glass sheet of claim 9.
